(19) United States
(12) Patent Application Publication
(10) Pub. No.: US 2014/0241589 A1
(43) Pub. Date: Aug. 28, 2014

(54) Method and apparatus for the detection of visibility impairment of a pane

(71) Applicants: Daniel Weber, Karlsruhe (DE); Annette Frederikson, Renningen (DE); Stephan Simon, Sibbesse (DE)

(72) Inventors: Daniel Weber, Karlsruhe (DE); Annette Frederikson, Renningen (DE); Stephan Simon, Sibbesse (DE)

(21) Appl. No.: 14/126,960

(22) PCT Filed: Jun. 6, 2012
(86) PCT No.: PCT/EP2012/060647

§ 371 Date: Apr. 4, 2014

(30) Foreign Application Priority Data
Jun. 17, 2011 (DE) 10 2011 077 725.3

(51) Int. Cl. G06T 7/40

(52) U.S. Cl. CPC G06T 7/407
USPC 382/108

(57) ABSTRACT

A method for determining a structural image of a pane, the structural image being suitable for the detection of a visibility impairment of the pane, especially raindrops. The method includes a step of removing a background brightness from an image of the pane, on which image a surface of the pane is shown in focus and a background of the pane is shown out of focus, in order to determine a structural image of the pane. In a further step, accentuation of image structures present in the structural image is carried out in order to determine an enhanced structural image of the pane.

### FIELD OF THE INVENTION

The present invention relates to a method for determining a structural image of a pane, to methods for the detection of visibility impairment or contamination of a pane, caused especially by raindrops, to a corresponding apparatus, and to a corresponding computer program product. The pane in question may be a pane of a vehicle or of a fixedly installed camera.

### BACKGROUND INFORMATION

The “classical” rain sensor for motor vehicles is situated behind the windshield pane in the region of the inside rearview mirror and is optically coupled to the windshield pane. Drops of water situated on the outside of the pane lead to the coupling-out of light produced by an infrared LED whereas, in the case of a dry pane, total reflection takes place. By determining the proportion of out-coupled light, a measure of the quantity of water on the pane is obtained. Based on that measure and its behavior with time, a signal for activating the windshield wiper is generated.

German patent document DE 10 2006 016 774 A1 discusses a rain sensor disposed in a vehicle. The rain sensor includes a camera and a processor. The camera takes an image of a scene outside of the vehicle through a windshield of the vehicle with an infinite focal length.

The processor detects rain on the basis of a degree of dispersion of intensities of pixels in the image.

### SUMMARY OF THE INVENTION

Against that background, the present invention presents a method for determining a structural image of a pane, a method for the detection of visibility impairment of a pane, caused especially by raindrops, a method for the detection of contamination of a pane, caused especially by raindrops, and further an apparatus that uses at least one of those methods, and finally a corresponding computer program product in accordance with the independent patent claims. Advantageous embodiments will be apparent from the respective subordinate claims and from the following description.

The expression “pane” is intended to be representative of panes, films or other light-permeable or radiation-permeable fittings situated in the image-capturing region of an image-capturing device. The pane may be part of the image-capturing device or may be spaced from the image-capturing device.

“Image” may be understood as meaning the entire image taken by a camera or a sub-area of such an image. The image may accordingly also contain only a sub-area of an imager, that is, if need be only a couple of pixels and not the entire image taken by the camera. In particular, an image evaluation may be applied only to such a sub-area.

The approach according to the present invention may be applied in general in connection with image-capturing devices. For example, the image-capturing device may be a fixedly installed camera, for example a surveillance camera. Alternatively, it may be a mobile image-capturing device disposed, for example, in a vehicle. The forms of embodiment and examples of embodiment described hereinafter relate representatively to an application in the automotive sector, but are transferrable without any problem to other areas of application in which the problem of visibility impairment, for example caused by rain, dirt, insects, scratches or water spray (from the person in front or from the windshield wiping system), also occurs.

The present invention is based on the realization that video-based rain detection in the case of a vehicle may be carried out based on an image depicting a pane or a detail taken from a pane of the vehicle, wherein the pane or an external surface of the pane is imaged in focus and a background of the pane is imaged out of focus. The rain detection may then be carried out based on structures of the image that are shown in focus. Structures that are shown out of focus may be removed from the image or reduced beforehand with the aid of suitable image processing.

The approach according to the present invention may be implemented in a rain sensor with image signal analysis, in which drops on the pane are detected and quantified in terms of amount and/or number. For that purpose, a camera that provides individual images or image sequences may be used.

The camera may be available exclusively to the rain sensor function. It is advantageous, however, to implement one or more driver assistance functions with the same camera. For example, the camera may be used at the same time for lane detection, traffic sign detection, detection of persons, vehicles or obstacles, for recognition of vehicles cutting in or for blind-spot monitoring.

The method is especially distinguished by being able to operate passively. Accordingly, no active lighting is required at the sensor. The ambient light available in the scene is already sufficient to ensure functioning. Optionally, it is also possible, however, to use active lighting in order to facilitate rain detection in very dark situations.

Advantageously, a rain sensor based on the approach according to the present invention may use one or more existing driver assistance cameras and therefore does not take up any additional central space swept by the windshield wiper and situated directly beneath the pane. Nor does a rain sensor according to the present invention have to be optically coupled to the pane so that light may be coupled into the pane and out of it again. Accordingly, there is no necessity for a non-positive connection that is stable over a long period and for which structural preparations would have to be made. With the rain sensor according to the invention it is possible to ensure a wiping behavior that is reproducible and therefore easy for the driver to comprehend, since with the method according to the present invention it is possible for effects caused by the condition of the pane, various types of drop, salt, dirt, soap, stone impact damage, scratches, temperature and ambient light to be recognized and taken into consideration.

It is especially advantageous that the approach according to the present invention makes possible an integration of driver assistance camera and rain sensor. It is possible to go far beyond a minimal solution of structural integration, in which the measuring principle of the classical rain sensor is retained but where housing, voltage supply and signal connection, for example via the CAN bus, are required only once. Instead, according to the invention it is possible to consider a driver assistance camera that offers rain detection as an additional function and that uses the existing image sensor, called an imager, at the same time for drop recognition.

The method according to the present invention is not limited to a specific camera assembly but functions with any camera in which the pane surface is focused and the rest of the scene is outside of the range of focus.

The present invention provides a method for determining a structural image of a pane, for example of a vehicle or a fixedly installed camera, the structural image being suitable for the detection of a visibility impairment of the pane, especially raindrops, the method including the following steps: removing a background brightness from an image of the pane, on which image a surface of the pane is shown in focus and a background of the pane is shown out of focus, in order to determine a structural image of the pane; and accentuating image structures present in the structural image in order to determine an enhanced structural image of the pane.

The vehicle may be a motor vehicle. The pane may be a windshield pane, a rear window pane or a different pane of the vehicle made, for example, of glass or another transparent material. In particular, it may be a pane that is capable of being cleaned by a wiping device of the vehicle, for example a windshield wiper. The fixedly installed camera may, for example, be a surveillance camera that has the pane or that is disposed behind the pane. The image may depict the entire pane or a sub-area of the pane. A pane may also be understood as being the outermost pane or lens of the camera's optical system. The visibility impairment may be contamination situated on a surface of the pane. The visibility impairment may impair a view of a vehicle occupant through the pane. The visibility impairment may have an inhomogeneous structure. For example, the visibility impairment may involve a plurality of individual raindrops. The visibility impairment may also involve dust particles, insects, tar spots, flecks of salt or other contaminants capable of impairing a free view through the pane. Visibility impairment may generally refer to a disturbance affecting the clearness or transparency of the pane. That also includes, for example, damage to the pane, for example caused by stone impact.

The image of the pane may be captured by an image-capturing device, for example a camera, and may be made available for further processing with the aid of the method according to the invention. The image-capturing device may be oriented toward an inside of the pane, that is, may be disposed, for example, in the interior of the vehicle in front of the pane. The image may be captured by an image-capturing device that is additionally configured to capture objects situated in an area surrounding the vehicle, for example further vehicles, people or traffic signs. The image used for the method according to the invention may be produced by such an image-capturing device by a portion of the beam path being split off and refocused by the camera. The image of the pane may be focused in such a way that the pane is in or almost in the depth of field range of the image-capturing device, but a background of the pane, which is situated outside of the vehicle, is outside of the depth of field range. Accordingly, at least one surface of the pane and a visibility impairment situated thereon are shown in focus on the image. The background, on the other hand, is shown out of focus or at least less focused than the surface of the pane. The background region shown out of focus may already begin at a few millimeters or a few centimeters behind the outside surface of the pane and may extend to infinity.

Accordingly, to remove the background brightness, components shown out of focus may be removed from the image. This may be carried out, for example, according to the principle of “unsharp masking”. The structural image therefore has the remaining regions of the image which are shown in focus and which form the structures of the visibility impairment. The structures may form areas or outlines of the visibility impairments. The structures may be subjected to image processing to enhance desired structures that are attributable to the visibility impairment and to reduce undesired structures that are attributable to the background and in that manner determine the enhanced structural image. Based on the enhanced structural image it is possible to detect the visibility impairment.

For that purpose, coherent structures, for example, in the enhanced structural image may be counted or the intensity values or brightness values of the individual image points of the enhanced structural image may be evaluated. The enhanced structural image also may be evaluated with the method according to the invention for the detection of a visibility impairment of a pane. The image of the pane may have a plurality of image points. Although it is possible in the case of the image processing steps carried out according to the invention to carry out the same operations image point by image point, the results are generally also dependent on the neighboring image points, for example in the case of a smoothing filter or in the case of a Sobel filter.

In accordance with one embodiment, in the step of accentuating, edge lines present in the structural image may be accentuated in order to determine the enhanced structural image of the pane, which enhanced structural image is suitable for the detection of the visibility impairment of the pane. The edge lines may run along abrupt or steep brightness changes in the image. The edge lines may be enhanced in order to accentuate them. In that manner it is possible, for example, to accentuate edges of visibility impairments in the structural image.

Alternatively or in addition, in the step of accentuating, extreme values present in the structural image may be accentuated to a greater extent than are further values present in the structural image, in order to determine the enhanced structural image of the pane. In particular, not only are minima and maxima accentuated, but all amounts different from zero are accentuated, and the more so, the greater is the difference of the amount from zero. The extreme values may be amplified in order to accentuate them. In addition to the extreme values, the other values of the structural image may also be amplified, in which case the absolute amplification may prove to be the lower, the further is a value from the extreme values. The extreme values may be especially light and especially dark regions of the structural image. By accentuating the extreme values it is possible, for example, to accentuate or suppress inner regions of visibility impairments and coronas around the visibility impairments. If both the edge lines and the extreme values are amplified, the structural images resulting therefrom may be combined, for example added together, in order to obtain the enhanced structural image. The accentuation may be effected by first converting all the values of the structural image into absolute values by absolute value generation and then amplifying the absolute values. The amplification may be carried out by multiplying by a factor. In that operation, all the absolute values may be multiplied by a factor that is the same for all the absolute values.

The method according to the present invention may further include a step of ascertaining the background brightness of the image in order to determine a background brightness image of the pane. In a step of combining, the background brightness image may be combined with the structural image and/or with the enhanced structural image in order to determine a corrected structural image of the pane, which corrected structural image is suitable for the detection of the visibility impairment of the pane.

The corrected structural image may be corrected for structures caused by the background brightness. In that operation, structures present in the structural image that are caused, for example, by background lighting may be removed or suppressed. The specific problem of background lighting is formed by almost point-shaped bright light sources which lead, after out-of-focus imaging, to “blur disks” which are still bright. Those “blur disks” have roughly the geometric shape of the camera aperture. In the exemplary embodiments described hereinafter they are round since the camera does not have an adjustable aperture. In the case of an adjustable aperture they would be hexagonal, for example. Although the point light sources are imaged very out of focus, the blur disks still form a clear outer contour, for example in the form of edges. It is important that those are suppressed.

In that respect, a step of enhancing edge lines present in the background brightness image may be carried out in order to determine an enhanced background brightness image. In the step of combining, the enhanced background brightness image may be combined with the structural image and/or with the enhanced structural image. The combination may be effected by subtraction. In that manner, interfering effects of the background may be reduced to an even greater extent.

In addition or alternatively, a step of accentuating bright regions of the background brightness image may be carried out in order to determine an additional enhanced background brightness image. In the step of combining, the additional enhanced background brightness image may be combined with the structural image and/or with the enhanced structural image. The combining may include a multiplication or division. The combining makes it possible to suppress structures of the structural image that are situated in regions of the structural image corresponding to the bright regions of the background brightness image. In that manner a leveling of the effect of the bright regions of the background is possible.

The present invention further provides a method for the detection of a visibility impairment of a pane, for example of a vehicle or of a fixedly installed camera, especially a visibility impairment caused by raindrops, which method includes the following steps: evaluating structures of a structural image of the pane, wherein on the structural image a surface of the pane is shown in focus and a background of the pane is shown out of focus, in order to detect the visibility impairment of the pane.

The structural image may be the enhanced structural image that was determined with the method according to the invention for determining a structural image. On the structural image, the structures of the visibility impairments, for example outlines or areas thereof, are shown in focus. Structures that are not caused by the visibility impairments on the other hand are shown out of focus or will already have been filtered out of the structural image or suppressed.

For example, in the step of evaluating, a mean value or a sum over the structural image or a number of structures may be determined. Accordingly, the visibility impairment of the pane may be detected based on the mean value, the sum or the number. For that purpose, a threshold value comparison with one or more thresholds may be carried out. For example, a visibility impairment may be deemed to exist if the mean value or the sum or the number exceeds a predetermined threshold.

In accordance with one embodiment, in a step of combining, a first structural image of the pane may be combined with at least one further structural image of the pane preceding it in time in order to determine a combined structural image of the pane. In the step of evaluating, structures of the combined structural image may be evaluated in order to detect the visibility impairment of the pane. In that manner it is possible to detect a change in the visibility impairments with time. It is possible to recognize both newly arrived visibility impairments, which are present only on the further structural image, and persistent visibility impairments which are present both on the first and on the further structural image.

For example, in the step of combining, a combination, for example multiplication, may be carried out between the first structural image and the further structural image. In that manner it is possible to accentuate structures that both the first structural image and the further structural image have. If cleaning of the panes is carried out between the structural images, then such structures may indicate a visibility impairment that is difficult to remove and which has been caused, for example, by insects or tar. If no cleaning of the panes is carried out between the structural images, then such structures may indicate a visibility impairment that is not automatically removed and that necessitates cleaning of the pane.

In accordance with this embodiment, in addition to or instead of recognizing a contaminant, it is possible to recognize a flaw affecting the transparency of the pane, for example damage to the pane. Damage to the pane, for example caused by stone impact, also leads in accordance with this embodiment to a detection that cannot be removed by wiping. To that extent, there are three cases. Firstly, drops, which may be removed by wiping. Secondly, further contaminants, which may be removed only by repeated or multiple wiping operations. The number of wiping operations required may vary widely in that case. Thirdly, it is possible to recognize flaws, for example stone impacts, which cannot be removed by wiping. By observation over a relatively long period of time that includes at least 3 images, which may be at least two of which have a relatively great time interval between them, it is possible to differentiate the three cases mentioned.

In addition or alternatively, in the step of combining, a combination, for example subtraction, may be carried out between the first structural image and the further structural image in order to accentuate structures that either only the first structural image or only the further structural image has. Structures that are recognizable only in the further structural image may indicate newly arrived visibility impairments. Structures that are recognizable only in the first structural image, on the other hand, may indicate visibility impairments that meanwhile have been removed or have changed their position.

With video systems being increasingly used in motor vehicles to implement driver assistance systems, such as, for example, night-vision systems or warning video systems, the video-based rain sensor is becoming ever more important. One possibility according to the present invention for a video-based rain sensor consists in evaluating a sharp image of the pane using image processing technology. Either the camera may be focused on the windshield or an additional optical element, such as a lens or a mirror, has to implement that focusing. To obtain refocusing it is possible to select an approach in which the optical additional component is integrated in the mounting frame or the housing of the camera. The image of the focused raindrops on the pane taken by the automobile camera may be evaluated by an image processing algorithm and the drops may be detected. This approach involves a purely passive system.

A further principle according to the present invention may be implemented in rain sensors based on the classical optical method which makes use of total reflection. Light which is coupled into the windshield at an oblique angle by a coupling element is emitted from a light-emitting diode (LED). If the pane is dry, the light is totally reflected one or more times at the outside of the pane and reaches a light-sensitive sensor, for example a photodiode or a photoresistor (LDR). If there are water drops on the pane, some of the light is coupled out at the outside of the pane and results in a lower intensity at the receiver. The reduction in the received amount of light at the photodiode is a measure of the intensity of the rain. The more water there is on the pane, the greater is the amount of light that is coupled out and the lower is the reflection. Depending on the amount of rain detected, the wiper system is actuated with a speed adapted to the state of wetting of the windshield.

That approach has the advantage that even in situations involving low ambient brightness or very low ambient contrast, for example in the dark, at night or in fog, detection may be carried out with certainty and even ambient conditions of that kind do not lead to any problems as regards detection certainty.

One approach according to the present invention consists in an alternating illumination of the pane. In this case, besides a first optical radiation, which may be ambient radiation, there is in addition a second optical radiation caused by an additional lighting source. When ambient brightness is very low, light beams originating from that second optical radiation may be reflected one or more times at the raindrops and a signal may thereby be received from the drops even in the absence of a first optical radiation. However, the probability of a beam of the second optical radiation being reflected at the inside of drops and being passed back in the direction of the camera is low.

By introducing a third optical radiation it is possible to generate an additional signal which offers information about the amount of rain on the pane. Together with the result from the second optical radiation, more reliable rain detection is provided precisely in difficult ambient situations, such as at night. Accordingly, complete reliability of drop detection is provided under all ambient conditions.

That approach according to the invention makes possible a reliable detection in the case of a video-based rain sensor with the aid of alternating illumination states under low-contrast ambient conditions. Alternating illumination states may therefore contribute in the case of a video-based rain sensor to reliable detection and to a better signal-to-noise ratio (SNR) in the dark.

Using that approach it is possible to eliminate the problem of drops not being detectable or of being detectable only with difficulty in the case of a uniform ambient background, for example at night. Thus, an improvement in the video-based rain sensor is possible and, in addition to optimization of installation space, a functionality better adapted to human perceptive faculties, a larger sensitive surface area, and a smaller pane area required for mounting, an additional advantage of the video-based rain sensor over current rain sensors is thereby provided. More reliable rain detection provides better visibility for the driver, resulting in safe driving at night and consequently in a lower accident risk. In addition, better use is made of already existing lighting. It is also possible to make use of the already existing optical additional elements for the refocusing, and the lighting turns the passive system of the video-based rain sensor into an active system.

Accordingly, the present invention further provides a method for the detection of a contamination of a pane, for example of a vehicle, especially contamination caused by raindrops, which method includes the following steps: evaluating a first image of the pane, which is based on a reflection of a first optical radiation, and a second image of the pane, which is based on a reflection of a second optical radiation, in order to detect the contamination, the first optical radiation being configured to be reflected at a contaminated region of the pane and the second optical radiation being configured to be reflected at a contamination-free region of the pane.

The first radiation and the second radiation may be provided by one or more radiation sources disposed in the interior of the vehicle. The first and second radiation may differ in respect of their wavelengths and in respect of their propagation direction relative to a surface of the pane, so that they have a differing reflection behavior at the pane. The first and second radiation may be provided in succession or simultaneously. The first radiation may be oriented in such a way that the first radiation meets the pane at an angle at which it is able to pass through the pane without reflection or with only slight reflection if the pane exhibits no contamination. If, on the other hand, the pane exhibits contamination, the first radiation is totally reflected or at least reflected to a very great extent by the contamination. The reflected first radiation may be captured by an image-capturing device, for example a camera. The image-capturing device is able to provide the first image based on the reflected first radiation. On the first image, regions of the pane at which the first radiation was reflected will be seen.

Thus, on the first image, it is possible to see those regions at which a contaminant is situated. With the aid of a suitable image evaluation those regions may be recognized and a corresponding item of information relating to the recognized regions exhibiting contamination may be output. The second radiation may be oriented in such a way that the second radiation meets the pane at an angle at which it is totally reflected or at least reflected to a very great extent at the pane if the pane exhibits no contamination. If, on the other hand, the pane exhibits contamination, owing to the contamination the second radiation is able to pass through the pane and the contamination without reflection or with only slight reflection. The reflected second radiation may be captured by the or a further image-capturing device. The image-capturing device is able to provide the second image based on the reflected second radiation. On the second image, it is possible to see regions of the pane at which the second radiation was reflected. Thus, on the second image, it is possible to see those regions at which there is no contamination. With the aid of a suitable image evaluation those regions may be recognized and a corresponding item of information relating the recognized regions exhibiting no contamination may be output. Thus, it is possible to detect contaminants based both on the first and on the second radiation.

For that purpose, the first image and the second image may be evaluated separately from each other or may be combined before the evaluation. In the step of evaluating, a mean value or a sum over the image or images may be determined. It is also possible to ascertain the number of those regions at which there are contaminants. Accordingly, the contamination of the pane may be detected based on the mean value, the sum or the number. For that purpose, a threshold value comparison with one or more thresholds may be carried out. For example, contamination may be deemed to exist if the mean value or the sum or the number exceeds a predetermined threshold value. In addition to the first radiation and the second radiation, the ambient radiation or ambient brightness may be evaluated. Based on the ambient radiation, a further image may be generated which in addition may be evaluated separately from the first and second image or may be combined with the first and second image before the evaluation. The further image may be a structural image determined according to the invention, a background brightness image determined according to the invention or a combination thereof.

In accordance with one embodiment, the first image or the second image may be inverted and superposed with the respective other image in order to determine a superposed image. In the step of evaluating, the superposed image may be evaluated in order to detect the contamination. As a result of one of the images being inverted before the superposing operation, both images show either those regions where there is contamination or alternatively those regions that are free of contamination.

The present invention further provides one or more apparatuses that are each configured to carry out or implement the steps of one or more of the methods according to the invention in corresponding devices. The object underlying the present invention may also be attained quickly and efficiently through these embodiment variants of the invention in the form of an apparatus.

An apparatus may be understood as being in this case an electrical device that processes sensor signals and outputs control signals in dependence thereon. The apparatus may have an interface which may be in the form of hardware and/or software. When in the form of hardware, the interfaces may, for example, be part of what is referred to as a system ASIC which includes a wide variety of functions of the apparatus. It is also possible, however, for the interfaces to be separate, integrated circuits or to consist at least partially of discrete components. When in the form of software, the interfaces may be software modules that are present, for example, on a microcontroller in addition to other software modules. Instead of implementation in an ASIC, FPGA implementation may be advantageous. For example, the data-intensive image processing components may be carried out on an FPGA and the further processing up to generation of the control signals may be carried out on a microcontroller.

Also advantageous is a computer program product having program code that may be stored on a machine-readable medium such as a semiconductor storage device, a hard disk storage device or an optical storage device and that is used to carry out the method in accordance with one of the embodiments described above when the program is executed on a device corresponding to a computer.

The present invention is described in more detail by way of example hereinafter with reference to the accompanying drawings.

### BRIEF DESCRIPTION OF THE DRAWINGS

FIG. 1 shows a schematic representation of an exemplary embodiment of the present invention.

FIGS. 2 to 4 show block diagrams of exemplary embodiments of the present invention.

FIGS. 5 to 15 show images of a pane in different processing states, in accordance with exemplary embodiments of the present invention.

FIG. 16 shows a schematic representation of a further exemplary embodiment of the present invention.

FIGS. 17 to 19 show schematic images of a pane, in accordance with exemplary embodiments of the present invention.

FIG. 20 shows a flow diagram of a method in accordance with the invention.

### DETAILED DESCRIPTION

FIGS. 21 to 24 show images of a pane, in accordance with exemplary embodiments of the present invention.

In the following description of exemplary embodiments of the present invention, the same or similar reference numerals are used for the elements having a similar action that are illustrated in the various Figures, dispensing with a repeated description of those elements.

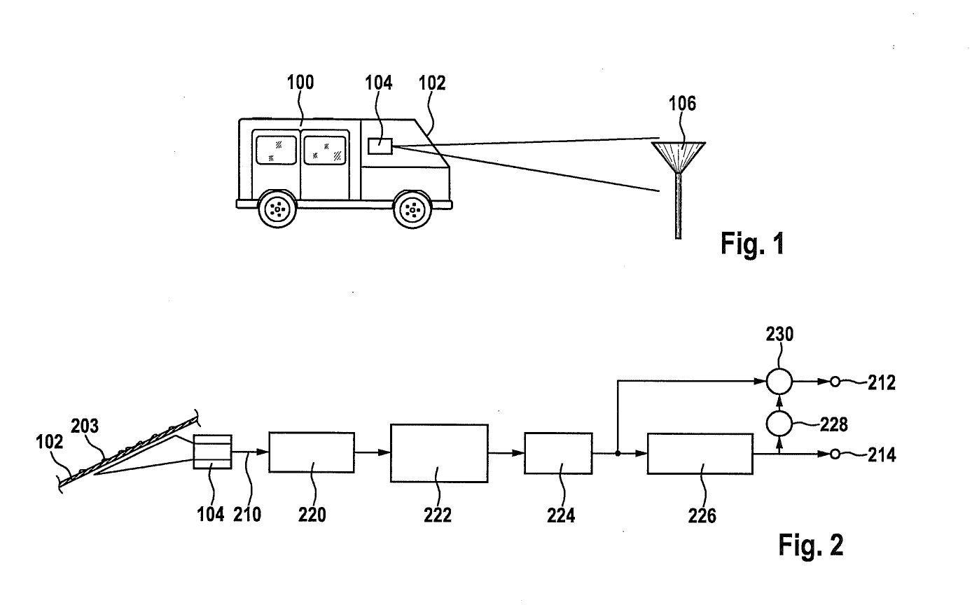

FIG. 1 shows a vehicle 100 with a pane 102 and a camera 104. Vehicle 100 is moving toward an object 106, for example a traffic sign. Pane 102 may be a windshield of vehicle 100. Camera 104 may be disposed in the interior of vehicle 100 in such a way that it is able to capture a surrounding area of vehicle 100 through pane 102. Camera 104 is configured to capture a sub-area of pane 102 and object 106 which is situated in a surrounding area of vehicle 100 and to provide a corresponding image. In accordance with this exemplary embodiment, a depth of field range of camera 104 is set in such a way that pane 102 is situated in the depth of field range of camera 104. On the other hand, the surrounding area of vehicle 100 and especially object 106 are situated outside of the depth of field range of camera 104. Accordingly, pane 102 and any visibility impairment or contamination possibly situated on pane 102, for example in the form of raindrops, are shown in focus on an image provided by camera 104. The surrounding area of vehicle 100 and hence also object 106 are shown out of focus on the image.

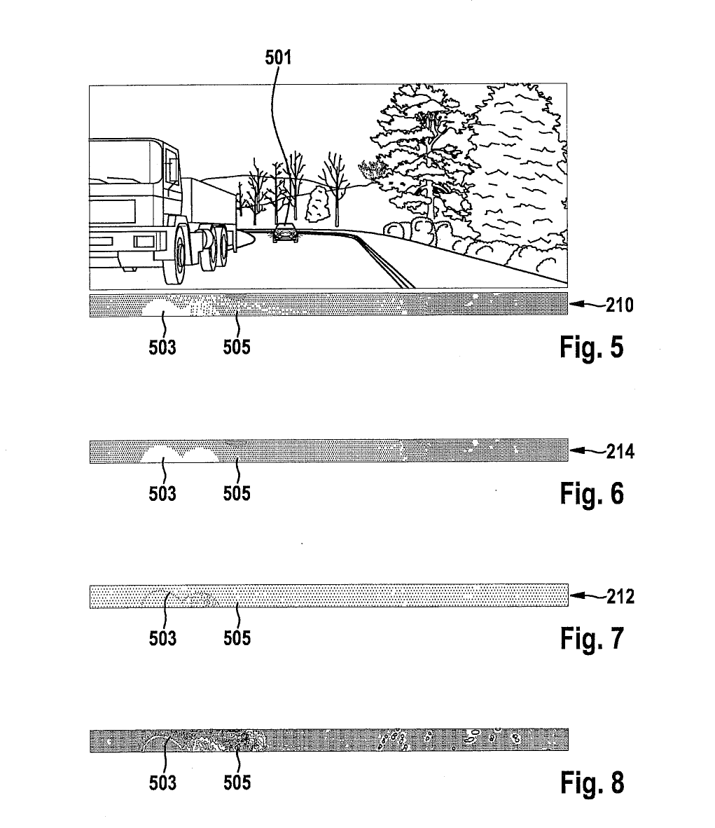

With regard to camera 104, a refocusing, for example using an optical mirror system, may be achieved. Owing to the refocusing, there is the possibility of selecting, for a secondary image involving an image focused on the pane, a different viewing direction than that for the primary image. It is also possible, therefore, to configure the beam of light of the secondary image in such a way that it looks toward the sky or toward the ground or to the side. An exemplary embodiment of a primary image and a secondary image is shown in FIG. 5.

The image provided by camera 104 may be used to detect visibility impairment of pane 102. For that purpose, the image may be subjected to appropriate image processing and image evaluation.

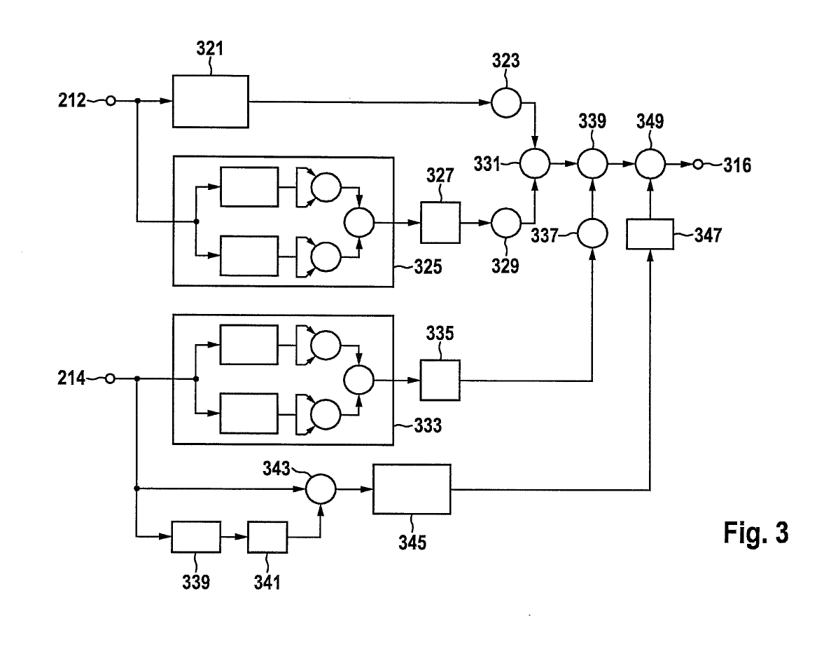

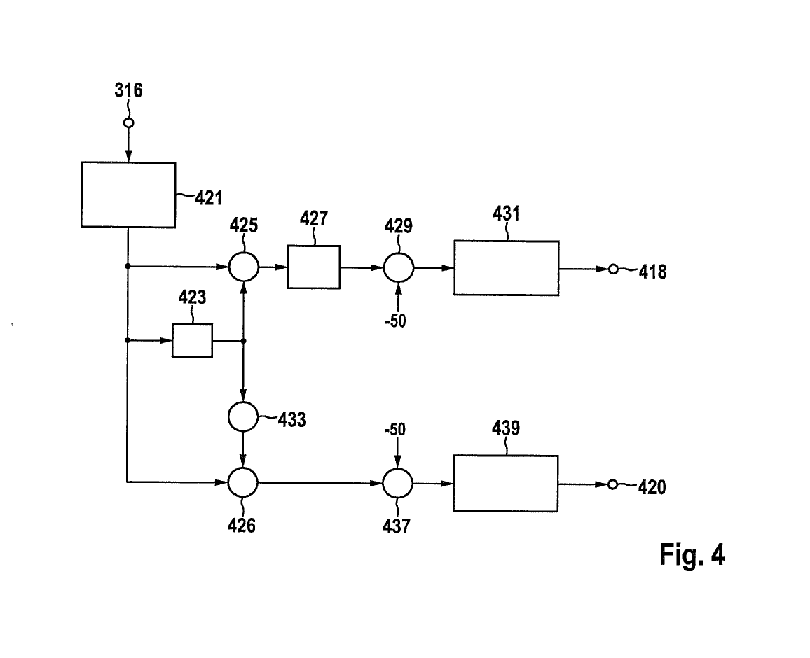

FIGS. 2 through 4 show a video-based rain detection subdivided into a plurality of subsections, in accordance with exemplary embodiments of the present invention. The subsections may be combined, so that the output data of the block diagram shown in FIG. 2 represent input data of the block diagram shown in FIG. 3, and the output data of the block diagram shown in FIG. 3 represent input data of the block diagram shown in FIG. 4. The block diagram shown in FIG. 2 is concerned with a determination of structures of an image of a pane on or in which visibility impairments are situated. The block diagram shown in FIG. 3 is concerned with accentuating the structures of the image, and the block diagram shown in FIG. 4 is concerned with an evaluation of the structures of the image with time in order to classify the visibility impairments on the basis of the structures and their behavior with time.

FIG. 2 shows a block diagram for determination of a structural image in accordance with an exemplary embodiment of the present invention. It shows a pane 102 and an image-capturing device 104. The pane may be the windshield of a vehicle shown in FIG. 1. Image-capturing device 104 may be the camera shown in FIG. 1, for example in the form of a rain sensor camera. On an outer surface of pane 102, opposite camera 104, there is a visibility impairment 203 in the form of a plurality of raindrops. A sub-area of pane 102 and raindrops 203 situated on the sub-area are in the image-capturing region of camera 104. Camera 104 is configured to provide an image 210. Image 210 may be made up of a plurality of individual image points. From image 210 it is possible to determine a structural image 212 and a background brightness image 214.

In accordance with this exemplary embodiment, image 210 and hence each image point is able to have a value range of 12 bits. Image 210 is provided to a device 220 for luminance extraction in which color information not required may be removed from image 210. Then, in a device 222, an adaptive histogram-based compression is carried out. In that operation, the value range of the image may be reduced, for example to 8 bits. Then, in a device 224, an image detail may be selected from image 210 and provided for further processing.

To determine background brightness image 214, structures shown in focus may be filtered out of image 210, so that the blurred structures of the background brightness remain. For that purpose, the image detail provided by device 224 may be filtered with a low-pass filter 226. Low-pass filter 226 may be configured in such a way that the local extent of its impulse response is approximately the same size as or larger than the dimensions in the image of the visibility impairments to be detected. Filter 226 may be configured to output background brightness image 214.

To determine structural image 212, the image detail provided by device 224 may be combined with background brightness image 214. To rid structural image 212 of background brightness, the principle of “unsharp masking” may be used. It is possible, therefore, for background brightness image 214 to be subtracted from image 210. For example, background brightness image 214 may be inverted and then, in a combination device 230, may be combined with, for example added to, the image detail provided by device 224. Accordingly, addition device 230 is able to output structural image 212. In accordance with this exemplary embodiment, the structural image is signed. Structural image 212 may have been rid of the background brightness.

To explain the image processing steps illustrated in FIG. 2, exemplary embodiments of an image 210, a structural image 212, and a background brightness image 214 are shown in FIGS. 5 through 7.

Devices 220, 222, 224 are optional. If they are used, they may also be arranged in a different order from that shown. In accordance with one exemplary embodiment, it is also possible for only structural image 212 to be determined. In that case, the visibility impairments may be determined based on structural image 212.

Alternatively, pane 102 and camera 104 may be disposed outside of a vehicle and, for example, be fixedly installed on a building. Pane 102 may be spaced from camera 104 or may be part of camera 104.

FIG. 3 shows a block diagram for determining an enhanced structural image 316 from a structural image 212 and a background brightness image 214 in accordance with an exemplary embodiment of the present invention. Structural image 212 and background brightness image 214 may be determined based on the method shown in FIG. 3.

Structural image 212 is received and passed on the one hand to a first signal processing branch, which has devices 321, 323, and on the other hand to a second signal processing branch, which has devices 325, 327, 329. Images resulting from the first signal processing branch and the second signal processing branch are combined with each other in a device 331.

The first signal processing device is configured to accentuate high-value amplitudes of the image points of structural image 212. In that manner it is possible to enhance both regions having a high degree of brightness and regions having a high degree of darkness. If the visibility impairment of the pane involves drops, it is possible in that manner to accentuate the interior of a drop. In addition, a corona around the drops is also accentuated in the process. If the image points of structural image 212 are signed, highly positive or highly negative values may be accentuated to a greater extent than are values close to zero. For that purpose, device 321 may be configured to perform absolute value generation abs( ). In that operation, it is possible to generate for each of the image points the corresponding absolute value. The absolute values provided by device 321 may then be amplified in device 323, for example by being multiplied by a factor. For example, the absolute values may each be multiplied by a factor of 16.

The second signal processing branch is configured to accentuate edge lines present in structural image 212. Edge lines may be accentuated irrespective of their orientation. In that manner it is possible to enhance outlines of visibility impairments, that is, for example, edges of drops. To accentuate the edge lines, suitable filters, for example Sobel filters, may be used in device 325. In accordance with this exemplary embodiment, two parallel filters are used for an x-orientation and a y-orientation, the output values of which filters are each squared and then combined with each other, for example added together, and, in device 327, subjected to root determination. Alternative configurations are also possible for device 325, for example by respective absolute value determination and subsequent addition of the two Sobel filter outputs. Root determination 327 may then be omitted. Then, a value adaptation may be carried out in device 329, for example by multiplication by a factor. The factor may have the value 0.5.

The image information provided by devices 323, 329 may be linked together in device 331, for example by addition. In accordance with further exemplary embodiments, it is also possible for only the first or only the second signal processing branch to be executed in order to determine enhanced structural image 316.

Background brightness image 214 may be used to rid enhanced structural image 316 of interference effects caused by the background brightness. The interference effects may be edges caused by a blurred imaging of point-shaped light sources situated in the background. For that purpose, background brightness image 214 may be received and passed on the one hand to a third signal processing branch, which has devices 333, 335, 337, and on the other hand to a fourth signal processing branch, which has devices 339, 341, 343, 345, 347. Images resulting from the third signal processing branch and the fourth signal processing branch may be combined in device 339, 349 with the image provided by device 331.

The third signal processing branch is configured to accentuate edge lines present in background brightness image 214. In that manner it is possible to accentuate brightness gradients. To accentuate the edge lines, suitable filters, for example Sobel filters, may be used in device 333. Device 333 may be configured in accordance with device 325. After filtering, root determination may be carried out in device 335 and inversion may be carried out in device 337. Device 339 may be in the form of an addition device in order to add together the image data provided by devices 331, 337. Thus, the brightness gradients determined in the third signal processing branch may be subtracted from structural image 212 which has been pre-processed in the first and second signal processing branches and thus may be suppressed in enhanced structural image 316. Alternative configurations are also possible for device 333, for example by respective absolute value determination and subsequent addition of the two Sobel filter outputs. Root determination 335 may then be omitted.

The fourth signal processing branch is configured to select regions of above-average brightness that are present in background brightness image 214. In that manner, a leveling of the effect of bright regions becomes possible. For that purpose, device 339 may be configured to determine a mean value mean( ) over background brightness image 214 and subsequent device 341 may be configured to determine a reciprocal value 1/x. In device 343, the image provided by device 341 may be combined, for example multiplied, with background brightness image 214. Then, in device 345, image values that are less than a threshold value, for example one, are set to one and image values that are greater than the threshold value are left unchanged. It is thus possible to implement a function max(x,1) in device 345. In device 347 which follows device 345, determination of a reciprocal value 1/x may again be carried out.

Device 349 may be configured to combine, for example multiply, the image data formed in the fourth signal processing branch with the image data of structural image 212 which has been pre-processed in the first and second signal processing branches, in order to obtain a leveling of the effect of the bright regions in enhanced structural image 316.

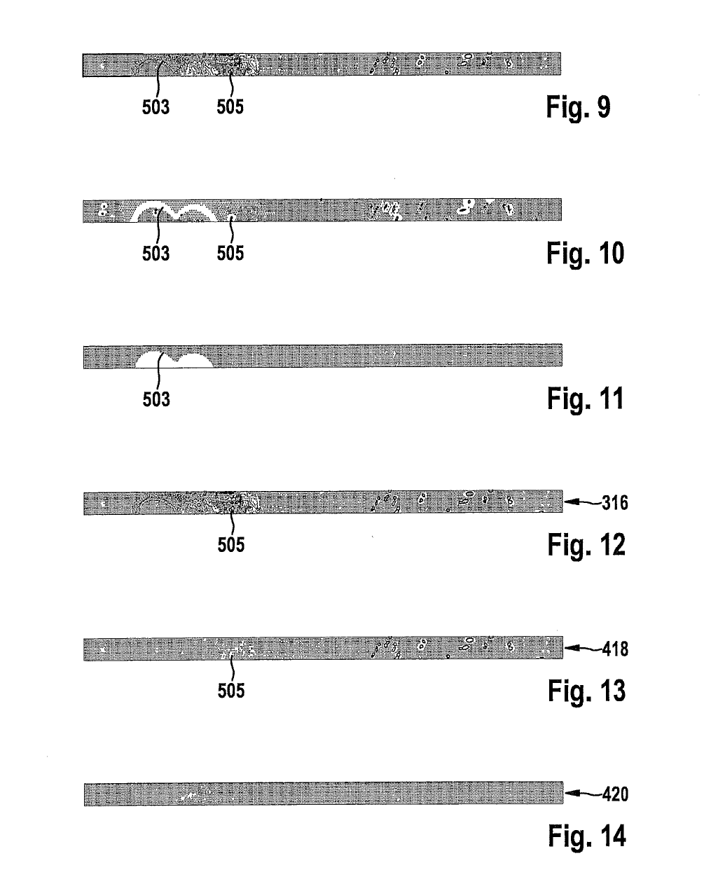

To explain the processing steps shown in FIG. 3, exemplary embodiments are shown in FIG. 8 of an image output by the first signal processing branch, in FIG. 9 of an image output by the second signal processing branch, in FIG. 10 of an image output by the third signal processing branch, and in FIG. 11 of an image output by the fourth signal processing branch, and in FIG. 12 enhanced structural image 316 is shown.

In accordance with further exemplary embodiments it is also possible for only the third, only the fourth or neither the third nor the fourth signal processing branch to be executed in order to influence enhanced structural image 316. Enhanced structural image 316 is substantially determined by the first two branches.

FIG. 4 shows a block diagram for the detection of a visibility impairment on the pane, based on enhanced structural image 316, in accordance with an exemplary embodiment of the present invention. Enhanced structural image 316 may be determined based on the method shown in

FIG. 3. In accordance with this exemplary embodiment, the visibility impairment may be drops and, based on enhanced structural image 316, it is possible to determine an image 418 comprising stable drops and an image 420 comprising new drops.

In accordance with this exemplary embodiment, in a device 421, first of all negative values of enhanced structural image 316 may be set to zero and positive values may be left unchanged. The function max(x,0) may be implemented in device 421. The image output by device 421 may be passed to a delay device 423 and to combination devices 425, 426. Delay device 423 is able to cause a delay by a time T which may correspond to a time interval between two consecutive images. Accordingly, in combination devices 425, 426, a current image may be combined with a predecessor. New drops, contaminants or visibility impairments may be defined by those that have newly arrived within the period T and that are therefore present only on the current image, but not on the preceding image.

In combination devices 425, 426, it is also possible to combine a plurality of images that are spaced apart in time. The time intervals between the combined images may each be identical or different. Image information from further back in time may be intermediately stored for that purpose in a suitable storage device. To recognize and classify different forms of visibility impairment, different images may be combined. To recognize a visibility impairment in general, a combination of merely two successive images may suffice. To recognize contaminants that are easy to remove, such as raindrops, a combination of merely two images taken with merely one wiping operation between them may suffice. To recognize contaminants that are difficult to remove, such as insects, a combination of three or more images taken with several wiping operations between them may be necessary. To recognize contaminants that are not removable by windshield wiping or also damage to the pane and to classify them as such, a combination of at least two images taken with a given number of wiping operations between them that is usually sufficient to remove other contaminants may be necessary. A visibility impairment that is already removed after one wiping operation may be classified as a contaminant that is easy to remove. A visibility impairment that persists over several wiping operations and that is removed again only after several wiping operations may be classified as a contaminant that is difficult to remove. A visibility impairment that is still present even after a large number of wiping operations may be classified as a non-removable visibility impairment. The classification may be carried out with the aid of a suitable classification device which specifies, for example, the images to be evaluated and their processing and evaluation.

To determine image 418 which comprises the stable drops, a geometrical mean formed over mutually corresponding image points of the current image and of the predecessor image may be determined image point by image point. For that purpose, the current image may be combined, for example multiplied, with the predecessor image in combination device 425. Then, in a device 427, root determination may be carried out. In a combination device 429, for example an addition device, a constant may then be added. In accordance with this exemplary embodiment, the constant may have a value of −50. In a further device 431, both an upper and a lower limit may be set for a value range of the image points of the resulting image. In device 431, it is possible to implement a function in which a trimming of the value range to a predetermined range, for example between 0 and 255 (both inclusive), takes place. Data output by device 431 form image 418 which comprises the stable drops.

To determine image 420 which comprises new drops, the predecessor image may be subtracted from the current image. For that purpose, an inversion device 433 and combination device 426, for example in the form of an addition device, may be used. The image output by combination device 426 may have a constant added to it in an addition device 437. In accordance with this exemplary embodiment, the constant may have a value of −50. In a further device 439, both an upper and a lower limit may be set for a value range of the image points of the resulting image. In device 439, it is possible to implement a function in which a trimming of the value range to a predetermined range, for example between 0 and 255 (both inclusive), takes place. Data output by device 439 form image 420 which comprises the new drops.

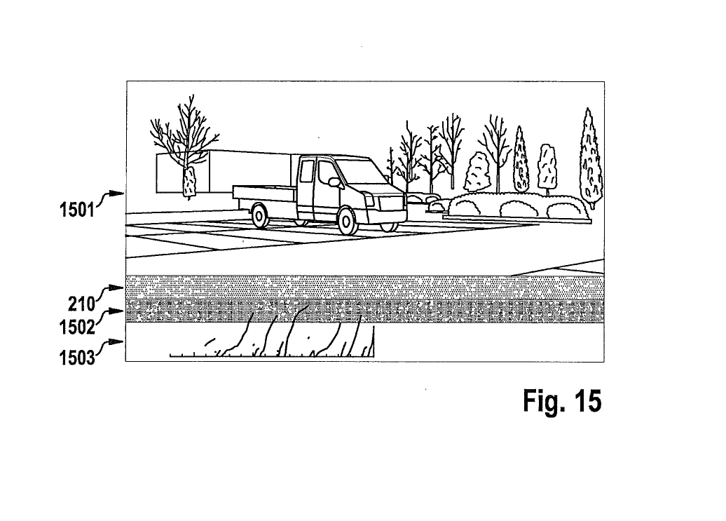

To explain the processing steps shown in FIG. 4, exemplary embodiments are shown in FIG. 13 of an image 418 comprising the stable drops and in FIG. 14 of an image 420 comprising the new drops.

In accordance with further exemplary embodiments it is also possible for only information 418 regarding the stable drops or only information 420 regarding the new drops to be determined and made available. In accordance with one exemplary embodiment, the two branches shown in FIG. 4 may also be omitted, that is to say, output 316 of FIG. 3 may be used directly in order to recognize the visibility impairment.

Image 418 comprising the stable drops and image 420 comprising the new drops may be evaluated by an image evaluation, for example to quantify the stable and the new drops.

In the following, the block diagrams shown with the aid of FIGS. 2 and 3 will be described in detail with reference to an exemplary embodiment of a video-based rain detection.

In accordance with this exemplary embodiment, it is assumed that a camera takes at least one image, which may be a continuous sequence of images, of a transparent pane, for example a vehicle windshield pane. In the case of a vehicle pane, the camera is situated in the interior of the vehicle. On the outside of the pane, there may be water drops which, when present, are to be detected and quantified in terms of amount and/or number.

The arrangement should be such that the drops are situated approximately in the depth of field range of the camera or a camera image detail. All other objects in the scene, for example the road, buildings, vehicles, pedestrians, trees or clouds, should be situated outside of the depth of field range.

This has the result that drops and other objects directly on the pane are imaged in focus whereas all objects of the scene are imaged out of focus. That property is utilized by the image processing method according to the invention which is described with reference to FIGS. 2 and 3.

As illustrated in FIG. 2, the camera provides an image of the (windshield) pane which is focused, at least in a sub-area, on the outside of the pane.

Since driver assistance scenes may have a high dynamic, the camera advantageously has a corresponding signal dynamic. For example, it is able to provide an output signal with a 12-bit resolution of the luminance.

If the camera uses color filters, first of all a luminance extraction (brightness signal) may take place if no use is subsequently made of color information. In accordance with the exemplary embodiment described here, no use is made of the color information. Alternatively, use may still be made of the color information. For example, the color information may be used to ascertain information about whether the blur disks were created by front light or back light. Corresponding information may be made available, for example, to further vehicle systems for further processing. If the color is not required, it is possible to use an image sensor in which the color filter imprint has been omitted at least on the secondary image part of the image sensor.

Furthermore, a global histogram-based compression of the input signal may be carried out to reduce the dynamic to 8 bits. In that case, based on the histogram of the luminance, it is possible to determine a compression characteristic curve which is subsequently applied to the gray scale values of all the image points using a lookup table. In that manner, an adaptation to differing input dynamics is achieved. The compressor characteristic curve is chosen in such a way that the output signal utilizes the available 256 gray scale values well in every situation and therefore a high signal entropy continues to be provided.

An image detail may then be extracted for rain detection. The order of compression and taking of an image detail may also be changed.

Resulting image 210 is shown by way of example at the bottom of FIG. 5. That image signal 210 may possibly have a very high dependence on the lighting in the scene. Here, for example, it may be seen that the headlamps of oncoming vehicle 501 result in large circles of light 503. In addition to the circles of light, a plurality of drops 505 will be seen, only one of which drops is provided with a reference numeral for the sake of clarity of the drawing. The first image detail shown at the top, the so-called primary image, may be used for the known driver assistance functions for detection of the surroundings, whereas the second image detail 210 shown at the bottom, the so-called secondary image, serves for rain detection.

In order to obtain extensive independence from ambient light, a separation into low-pass component and high-pass component is carried out. That may be achieved, for example, by low-pass filtering and determination of the difference.

The high-pass component is referred to hereinafter as the structural image, and the low-pass component as the background brightness image.

FIG. 6 shows a background brightness image 214. Background brightness image 214 results from the low-pass filtering of the secondary image. In background brightness image 214, the large circles of light 503 have been made prominent.

FIG. 7 shows a structural image 212, in this case raised by a constant gray scale value for visualization purposes. Structural image 212 still has the structure of drops 505, but has been largely rid of the effect of the background brightness. Merely edges of the circles of light 503 are to be seen.

As shown in FIG. 3, the absolute value is then determined on structural image 212. Since structural image 212 has been rid of the low-pass component, the interior of the drops is accentuated in that manner, but so is a corona around the drops. Therebetween there is generally a zero crossing, as shown by reference to FIG. 8.

FIG. 8 shows an absolute value of the structural image to accentuate the interior of drops. The absolute value may be determined by device 321 shown in FIG. 3.

On a further path, which may include devices 325, 327 shown in FIG. 3, the edges of the drops are accentuated. That is done by determining the absolute value of the gradient, it being possible to use Sobel filters in the x- and y-direction to determine the gradient. A resultant image is shown in FIG. 9.

FIG. 9 shows the absolute value of the gradient from the structural image to accentuate the edges of the drops.

The absolute value of the structural image shown in FIG. 8 and the absolute value of the gradient from the structural image shown in FIG. 9 are then combined, in this case by weighted addition.

The unwanted response to the large bright circles 503 caused by the oncoming headlamps is suppressed by also carrying out a determination of the absolute value of the gradient on the background brightness image. Those brightness gradients are especially pronounced at the edge of the circles, as may be seen from FIG. 10.

FIG. 10 shows the absolute value of the gradient from the background brightness image to accentuate the edges of the circles of light and the corona of drops 505. The absolute value of the gradient from the background brightness image may be determined using devices 333, 335 shown in FIG. 3.

The absolute value of the gradient from the background brightness image shown in FIG. 10 is combined with the previous intermediate result, which may be by weighted subtraction. That may be done by device 339 shown in FIG. 3. In that manner, the desired suppression of edges of circles of light and corona of drops 505 takes place.

Since drops in front of a light background also produce high absolute values of the gradient and high absolute values in the structural image, an additional leveling is also introduced which reduces that unequal valuation.

For that purpose, in the lower path of the block diagram shown in FIG. 3, a normalization function is formed which acts only on image regions whose background brightness is greater than the average background brightness. The remaining image regions remain unaffected. FIG. 11 shows where that leveling becomes effective. FIG. 11 shows that in regions with above-average brightness the effect of lighting is reduced.

Using all of the measures mentioned so far, an intermediate result image is obtained. In the intermediate result image, as shown in FIG. 12 drops 505 are already detected well. Only a very slight influence of the background brightness still remains.

FIG. 12 shows the intermediate result 316, based on the evaluation of a single input image.

As shown by reference to FIG. 4, further advantages are obtained from the combination of the current intermediate result image shown in FIG. 12 with at least one intermediate result image preceding it in time. In the block diagram shown in FIG. 4, by way of example two advantageous combinations of that kind are carried out.

Firstly, an image point by image point determination of the geometric mean results in the continued existence of only those responses that are other than zero in both images. At the same time, weak responses are suppressed. That is achieved in the upper branch shown in FIG. 4.

FIG. 13 shows a result image 418 for stable drops. The procedure for determining the result image 418 for stable drops has several advantages.

For example, particularly at night, noise suppression takes place, since the camera noise and its effect on the intermediate result image shown in FIG. 12 occur in two successive images statistically independently of each other. Nor do moving drops lead to a response or they lead only to a weak response. That is advantageous if, for example, with a well sealed pane and at high driving speed or at high inherent weight, the drops rapidly run off the pane automatically. In that case, wiping is not necessary and may even be undesirable. What is involved, therefore, are the locally stable drops which can be detected in that manner.

Secondly, it is furthermore possible to carry out a determination of a difference with the preceding intermediate result image, as in the lower path shown in FIG. 4. It is thereby possible to accentuate the drops that have newly arrived. Owing to the optional limitation to values that exceed a positive threshold, only drops that have arrived are detected, but not drops that have disappeared. It will be appreciated that it would also be possible to detect the drops that have disappeared, namely by considering the negative-value results.

FIG. 14 shows a result image 420 for newly arrived drops.

A limitation of the output values downward and upward is ultimately used here in both output channels, that is, in the output channel concerned with the stable drops and the output channel concerned with the new drops, in order to ignore small output values, for example noise, and in order to limit the effect of bright drops once more. In FIG. 4, corresponding limitations are implemented by devices 431, 439.

An exemplary embodiment of an evaluation of the images determined by the methods described with reference to FIGS. 2 through 4 is described below.

On the basis of the two output images, namely of the stable drops shown in FIG. 13 and of the new drops shown in FIG. 14, an evaluation is made and the windshield wiper, not shown in the block diagram in FIG. 4, is activated. In the simplest case, the sum or the mean value taken over the output images is calculated. The mean value taken over the image of the stable drops represents a measure of the amount of rain present on the pane. The mean value taken over the image of the new drops provides information about what quantity of rain arrives per unit of time, that is to say, how hard it is raining.

FIG. 15 shows a compact visualization of the most important intermediate results on a screen. In the visualization, a primary image 1501 is shown at the top and, below it, secondary image 210. Further down, the detected stable drops and the new drops are to be seen in an image 1502. The stable drops and the new drops may be displayed in different colors. For example, the stable drops may be displayed in yellow and the new drops in green. The curve 1503 thereunder represents the variation with time of the mean value taken over the respective image of the stable drops. In that variation, it will be seen how the pane is cleared in each case by the forward wiping movement and the backward wiping movement which follows shortly thereafter, and how the curve jumps back to zero or to a value close to zero in each case.

Primary image 1501 is focused on the scene to be captured or at infinity or beyond infinity. For that reason, the drops on the pane appear blurred in primary image 1501. In the case of the picture taken in FIG. 15, the pane was sprinkled artificially and that is why the ramps in variation 1503 are of such differing steepness.

Instead of or in addition to a mean value being determined, a count of the drops may be made or an approximation of the number of drops may be determined. A labeling algorithm of the kind known in image processing is suitable for the counting operation. For an approximative count, simpler methods also come into consideration, for example using the count of the (bit) changes in a binarized detection image involving line-wise and/or column-wise passes.

For further processing, recourse may be had to known image processing algorithms.

The method according to the present invention is also suitable for detecting snow and ice particles on the pane. Since those are situated in the depth of field range upon contact with the pane and therefore result in sharp image contours, the method according to the present invention is also effective in that case.

Individual method steps described with reference to FIGS. 2 through 4 may be simplified. Using such possible simplifications, it is possible to obtain results of almost identical quality with reduced effort on computation.

There may be mentioned as an example the determination of the absolute value of two-dimensional vectors, which occurs twice in the block diagram shown in FIG. 3, namely when determining the absolute value of the gradient in the structural image and in the background brightness image. The ideal rule

z=\sqrt{x²+y²} (1)

may be simplified to

z≈c·(max(|x|,|y|)+0.5·min(|x|,|y|) (2)

where c≈0.92. The computationally more expensive squaring and root determination are avoided in that manner. The person skilled in the art will be able to provide similar further simplifications.

With the approach according to the present invention, a treatment of persistent dirt or a damaged pane is also possible.

As a rule, the drops and hence the detection results disappear as a result of the wiping operation. The reason for the detections may, however, be of a different nature, for example caused by insects that have stuck to the pane, by tar splashes or by damage to the pane as a result of stone impact, scratches, or also damage to the optical system or the imager, or dust particles in the internal beam path.

In accordance with one embodiment, detections of that nature do not have an influence on the activation of the windshield wiper. That may be achieved by setting the detection results in relation to one another at greater time intervals. For that purpose, it is particularly advantageous to use in each case an image from a time shortly after the wiping operation, that is to say, when the pane should be substantially free of water. If it is established for the respective image point that detections are regularly occurring despite the wiping that has just taken place, it may be assumed that there is a persistent disturbance at the corresponding location on the pane.

If that disturbance has been caused by an insect stuck to the pane, then with continuous rain and use of the windshield wiper it will disappear again at some time or other. Depending on the weather, this may take from minutes to hours. A tar spot may be more stubborn. The disturbance it causes will disappear perhaps only after thorough cleaning of the pane with solvent. Damage in the glass of the pane, such as a stone impact hole or scratches, or a disturbance in the optical system will not disappear through cleaning measures. The disturbance will therefore be present permanently.

By selecting different time intervals of the images that are set in relation to one another it is possible to determine the degree of stubbornness of the disturbance. As an advantageous alternative to the time interval, the number of wiping cycles or the amount of water removed by wiping may be used as an “interval dimension”. The different intervals may be implemented in each case by delay element 423 shown in FIG. 4.

Detections that are not directly eliminated or that are never eliminated by wiping may therefore be established algorithmically. It is thus possible to leave those disturbed image point out of consideration or to give their influence less weight in the further evaluation. The result of the rain sensor then remains unaffected by such disturbances. In that manner it is possible to avoid unnecessary wiping operations.

In accordance with one exemplary embodiment, automatic use of wiping water may be effected. Using the wiping water, it is possible to clean the pane.

Even on journeys in dry or almost dry weather, an accumulation of dirt on the pane may occur. In summer, depending on the region, predominantly dead insects and insect dirt, dust, dirt from trees and from aphids on trees, and also bird droppings collect on the pane. Those kinds of contamination generally accumulate far more slowly than raindrops, whereby a distinguishability from rain is already provided without the use of the wiper.

If the wiper is used, the distinguishability from rain is even greater, since dirt of the mentioned kinds can scarcely be removed when dry.

It is therefore advantageous for the windshield wash function or windshield wipe function to be automatically activated, that is, for the window washing water pump and then the wiper to be switched on briefly or long enough or often enough until an improvement in the condition takes place. The same applies in winter when contamination is usually caused by water thrown up from the road, in which road salt in particular is dissolved. Upon drying on the pane, the salt remains there and leads within minutes to contamination for whose removal the automatic use of the windshield wash function or windshield wipe function is also advantageous.

In that connection, the windshield washing water pump may be switched on specifically when dry contamination has been recognized or it may be switched on, for example, every time the windshield cleaning function is activated for the first time, it being possible for the activation for the first time to be an activation following a predetermined idle period.

In accordance with a further exemplary embodiment, back-lighting of the pane may be carried out.

The method according to the present invention functions as a passive sensor without active lighting of the pane or the drops. The ambient light present in the scene is already sufficient to ensure the rain sensor function. Active lighting may therefore be regarded as an option.

The advantage of back-lighting, which as the case may be is also used only intermittently, is that the sensor functions and is able to actuate the windshield wiper correctly even in a completely dark environment. If the scene then becomes lighter again, the pane will already have been wiped correctly and the driver will immediately have unimpeded visibility.

The lighting may be carried out with visible light or also with light that is invisible to humans, which may be infrared light. The spectral composition of the light and the spectral sensitivity of the camera are to be matched to each other.

Locally, the lighting should be disposed in such a way that as far as possible only the pane area used for the rain detection is illuminated. The pane passage area used for the driver assistance functions should as far as possible be excluded from the lighting in order to avoid undesirable interference. Two basic principles come into consideration for the disposition of the lighting.

On the one hand, use of light reflections in drops or rather at the drop-to-glass interface is possible. Whereas the light normally passes through the pane to the outside and no longer returns to the sensor, a drop on the pane leads to light being thrown back by drops in places and reaching the sensor. Reflection effects, multiple reflection effects and refraction effects play an important role here.

On the other hand, use of total reflection at the pane is possible. The classical rain sensor also operates according to that principle. The light is coupled in at the inside of the pane at a given angle with the aid of an optical in-coupling element, so that total reflection occurs at the dry outside of the pane. The presence of drops interrupts the total reflection at those locations and leads to local instances of out-coupling of light to the outside. The image thus produced at the pane may be coupled out again by an out-coupling element and analyzed.

Several possibilities also come into consideration for the time control of the light source.

In the simplest case, the light source is not modulated but is constantly switched on. The algorithm according to the invention for drop detection then takes effect directly since, as a result of the illumination of the drops, sharp image contours are produced which make it possible to infer the presence of the drops.

In addition, using a modulatable source, it is possible to capture, for example alternately, an image with back-lighting and an image without back-lighting or with reduced back-lighting intensity. By evaluating the difference between those two image types, it is then possible to infer the presence or absence of drops. Instead of intensity modulation, the spectral composition of the light may also be modulated. That may be achieved, for example, by two or more LED modules of differing spectral composition (color). The corresponding demodulation may be carried out with a color camera.

A further degree of freedom consists in positioning a plurality of light sources in different places. The modulation then switches back and forth between the light sources. Correspondingly, the reflections in the drops occur at different places, as may be established, for example, by differential image processing.

In accordance with a further embodiment, a forward projection in time may be carried out in the absence of back-lighting.

Even with the passive system, that is, without back-lighting, it is possible to bridge phases of darkness. If the scene is at times so dark that rain detection is not possible, the current wiping period may simply be projected forward, where appropriate also with a slightly altered, which may be extended, period. That procedure makes sense because phases of complete darkness are actually almost never encountered since the reflection of the dipped beam lights from a reflector post already suffices to illuminate the drops at least to some extent.

Furthermore, a rain phase seldom ends abruptly. At least, there is usually still so much wetness on the pane or on the wiper blades that a few further wiping cycles are possible without chattering.

The approach according to the present invention may also be used in connection with cleaning of a rear window pane or with cleaning of headlamps. A sensor location may be installed accordingly. The exemplary embodiments according to the invention may accordingly also be translated to vehicles having a wipe and/or wash function for further panes, especially for the rear window pane and the panes in front of lighting units and in front of further sensors. Furthermore, the video-based rain sensor does not have to be situated behind the windshield in the region of the rearview mirror. Other positions may also be sensible, especially when there is a cleaning device at those positions.

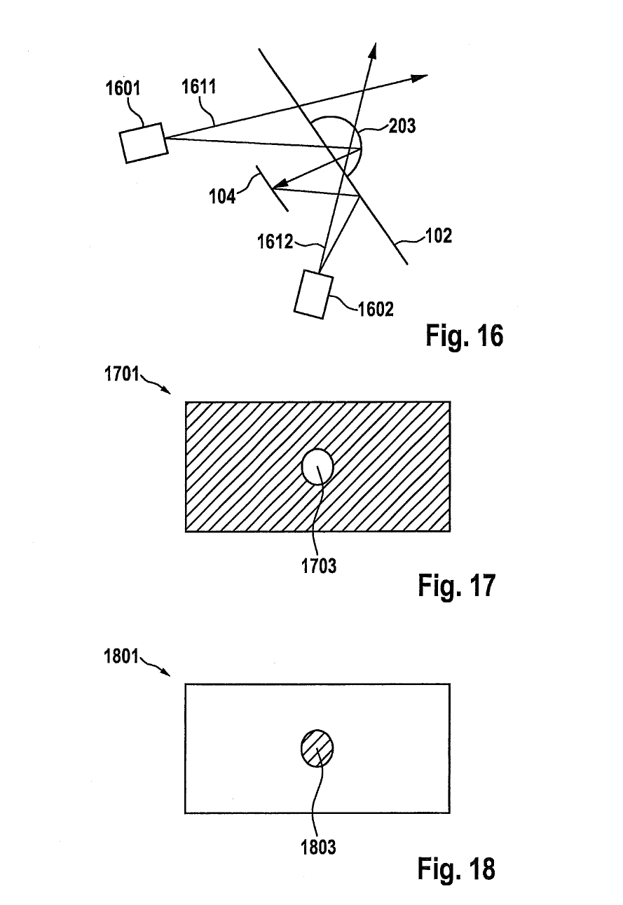

FIG. 16 shows a pane 102 of a vehicle and an image-capturing device in the form of a camera 104 disposed in the vehicle. On an outside surface of pane 102, there is contamination in the form of a drop 203. Disposed in the interior of the vehicle there is also a first light source 1601 and a second light source 1602. First light source 1601 is configured to emit a first radiation 1611 in the direction of pane 102. Second light source 1602 is configured to emit a second radiation 1612 in the direction of pane 102. Pane 102 may be situated in the depth of field range of camera 104.

An illustrated first beam of first radiation 1611 impinges on a region of pane 102 that is free from contamination. In that case, the first beam of radiation 1611 is able to pass through pane 102 and is not reflected. An illustrated second beam of first radiation 1611 impinges on a region of pane 102 in which drop 203 is situated. In that case, the second beam of first radiation 1611 is reflected owing to drop 203. The reflected second beam of first radiation 1611 is captured by camera 104. The desired reflection behavior of first radiation 1611 at pane 102 may be adjusted by a suitable angle of incidence of first radiation 1611 on a surface of pane 102. For that purpose, first light source 1601 may be oriented accordingly.

Camera 104 is configured to provide a first image on which reflections of first radiation 1611 are to be seen. The greater the number of beams of first radiation 1611 that are reflected, the more contaminants 203 there are on the pane. Thus, contaminants 203 on pane 102 may be inferred from the amount of reflected first radiation 1611. The amount of reflections or a measure for quantifying the reflections may be determined by an evaluation of the intensity variations or brightness variations of the first image. First light source 1601 and camera 104 may be coupled to each other, so that the emission of first radiation 1611 by first light source 1601 and the capturing of the first image by camera 104 may take place in synchronized manner.

An illustrated first beam of second radiation 1612 impinges on a region of pane 102 that is free from contamination. In that case, the first beam of second radiation 1612 is not able to pass through pane 102 but is reflected at pane 102. An illustrated second beam of second radiation 1612 impinges on a region of pane 102 in which drop 203 is situated. In that case, owing to drop 203 the second beam of second radiation 1612 is not reflected and is able to pass through pane 102 and drop 203. The reflected first beam of second radiation 1612 is captured by camera 104. The desired reflection behavior of second radiation 1612 at pane 102 may be adjusted by a suitable impingement angle of second radiation 1612 on a surface of pane 102. For that purpose, second light source 1602 may be oriented accordingly. For example, first radiation 1611 may impinge on the surface of pane 102 at a smaller angle of incidence than second radiation 1612. Camera 104 is configured to provide a second image on which reflections of second radiation 1612 are to be seen. The greater the number of beams of second radiation 1612 that are reflected, the fewer contaminants 203 there are on pane 102. Thus, contaminants 203 or an absence of contaminants 203 on pane 102 may be inferred from the amount of reflections. The amount of reflections or a measure for quantifying the reflections may be determined by an evaluation of the intensity variations or brightness variations of the second image. Second light source 1601 and camera 104 may be coupled to each other, so that the emission of second radiation 1612 by second light source 1602 and the capturing of the second image by camera 104 may take place in synchronized manner.

The disposition of camera 104 and of light source 1601, 1602 has been selected merely by way of example and may be varied. In addition, first radiation 1611 and second radiation 1612 may be emitted from one and the same light source. Camera 104 may be additionally configured to capture a third image on which a background brightness is reproduced. While the third image is being captured, light sources 1601, 1602 may be switched off.

The arrangement shown in FIG. 16 is illustrated in highly simplified form. For reflection, the Fresnel reflections at the pane are utilized. Alternatively, it is also possible to utilize the total reflection at the pane, in which case a coupling element (not shown in FIG. 16) may be provided for coupling the beam in and out. With the aid of the coupling element the beam may be coupled into the pane at an angle that permits the total reflection inside the pane to be utilized.

FIG. 17 shows a schematic representation of a first image 1701 which may be determined, for example, by camera 104 shown in FIG. 16 on the basis of reflections of first radiation 1611. A bright region 1703 in first image 1701 may be attributed to a contaminant at which some of the first radiation is reflected. The more bright regions 1703 first image 1701 has, the more contaminants there are on the pane. The brightness of first image 1701 may be determined using suitable evaluation methods. With the aid of a suitable attribution rule or a lookup table, the brightness may be associated with a degree of contamination of the pane. The degree of contamination may indicate, for example, the percentage of the pane covered by raindrops.

FIG. 18 shows a schematic representation of a second image 1801 which may be determined, for example, by camera 104 shown in FIG. 16 on the basis of reflections of second radiation 1612. A dark region 1803 in second image 1801 may again be attributed to contamination at which some of the second radiation is not reflected. The more dark regions 1803 second image 1801 has, the fewer contaminants there are on the pane. The brightness or darkness of the second image may be determined using suitable evaluation methods. With the aid of a suitable attribution rule or a lookup table, the brightness or darkness may again be associated with a degree of contamination of the pane.

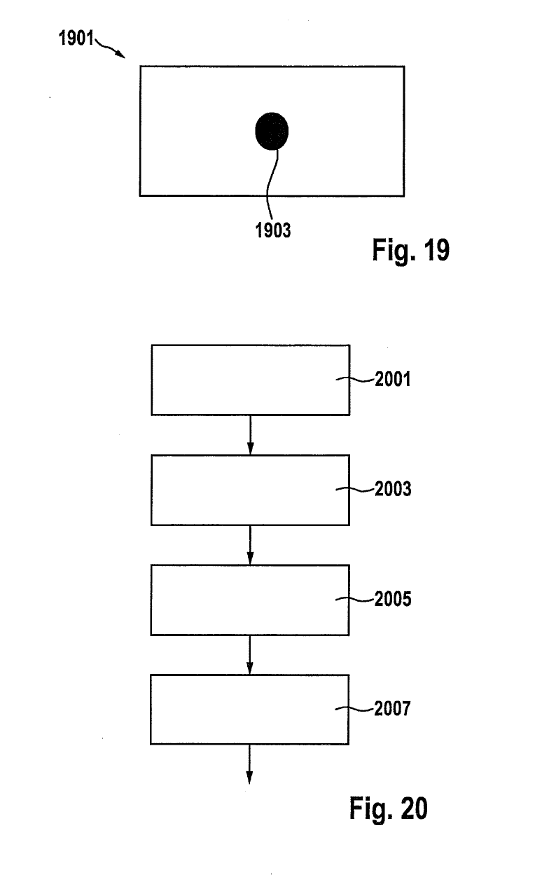

FIG. 19 shows a combined image 1901 established by superposing images 1701, 1801 shown in FIGS. 17 and 18. One of images 1701, 1801 is inverted before the superposing operation. In accordance with the exemplary embodiment, image 1701 shown in FIG. 17 has been inverted in relation to the brightness values of its image points before the superposing operation. As a result of the inversion, originally bright regions appear dark and vice versa. By combination of the image information of images 1701, 1801, a region 1903 of combined image 1901 is clearly accentuated. In accordance with this exemplary embodiment, region 1903 is shown distinctly darker than the surrounding region of image 1901. Region 1903 marks a contamination of the pane. The more dark regions 1903 combined image 1901 has, the more contaminants there are on the pane. The brightness or darkness of combined image 1901 may be determined using suitable evaluation methods. With the aid of a suitable attribution rule or a lookup table, a degree of contamination of the pane may be associated with the brightness or darkness.

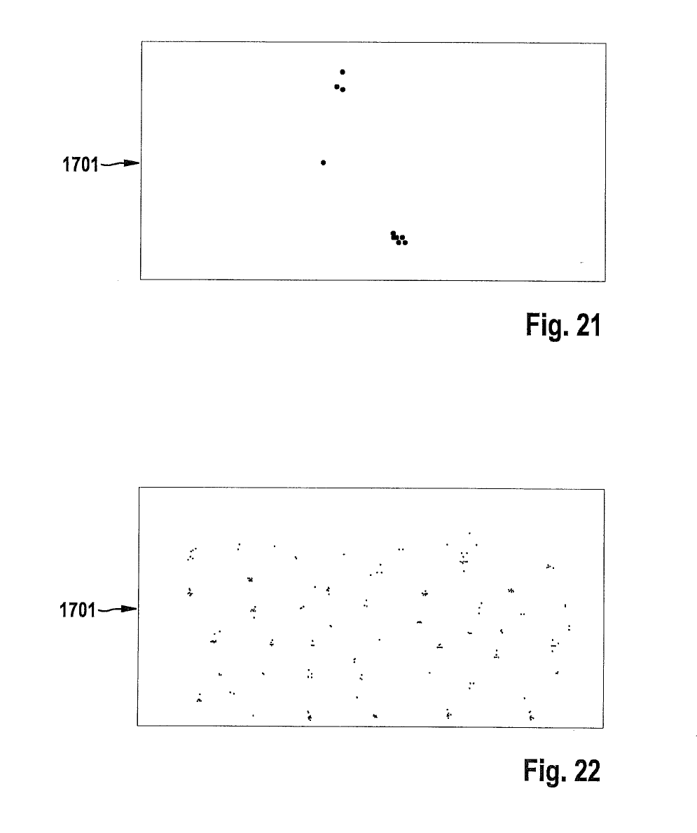

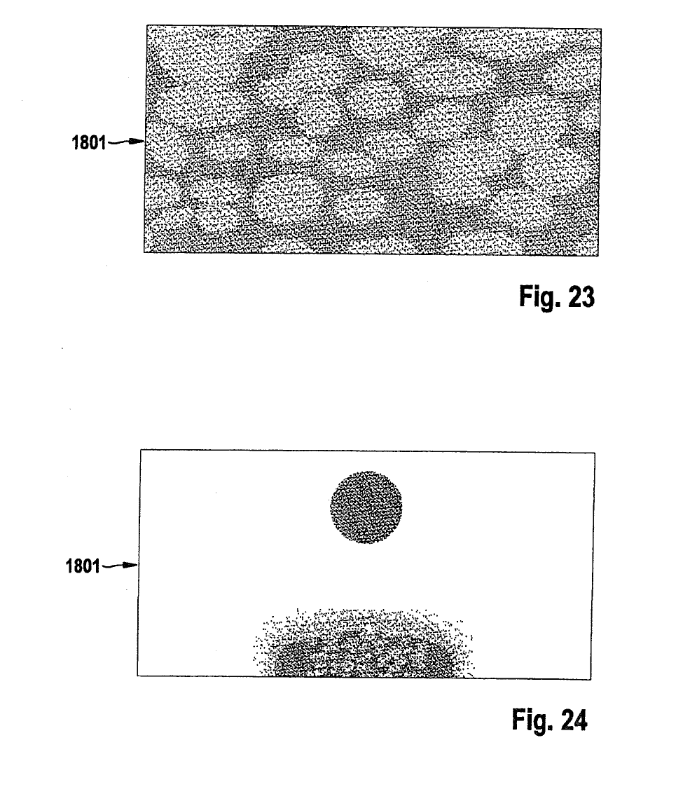

FIG. 20 shows a flow diagram of a method for the detection of contamination of a pane of a vehicle, especially contamination caused by raindrops. In a step 2001, a first radiation and a second radiation may be emitted in the direction toward the pane. In a step 2003, reflections of the first radiation and of the second radiation may be captured. In that operation, the first radiation and the second radiation may be emitted in succession. Alternatively, the first radiation and the second radiation may be emitted simultaneously. In that case, the reflections of the first and second radiation may, for example, be captured by different capturing devices or be distinguished from each other by wavelength-selective detection when a plurality of wavelengths are used. In a step 2005, a first image and a second image may be output. The first image depicts the reflections of the first radiation at the pane. The second image depicts the reflections of the second radiation at the pane. In a step 2007, the first image and the second image may be evaluated in order to determine the contamination of the pane. The reflections of the first radiation and of the second radiation at the pane are influenced by the contamination. In the knowledge of that influence, it is possible to infer the contamination from the first image and the second image. The first image and the second image may be evaluated separately from each other and then the evaluation results may be combined. Alternatively, the image information of the first image and of the second image may be combined first and then an evaluation may be carried out. For the evaluation, suitable image evaluation methods may be employed which, for example, analyze an average brightness variation of an image or analyze structures present in an image.

The method for the detection of contamination of a pane in accordance with an exemplary embodiment of the present invention will be described in detail with reference to FIGS. 21 through 24.

For better drop recognition it is accordingly possible to use an additional, second optical radiation which differs from a first optical radiation. In the case of the first optical radiation, the total reflection at the drop surface is utilized. That produces bright spots on the image at sites where the drops are situated on the pane, as will be seen in FIGS. 21 and 22. In this case, the pane is to be lit from the inside in such a way that light beams pass through when the pane is dry. When there are drops on the pane, rays that meet a drop are diverted within the drop by multiple total reflection and in that manner reach the optical system. The angle at which the radiation meets the pane should be selected in such a way that as few Fresnel reflections as possible take place.

FIG. 21 shows an image 1701 depicting a simulation of the reflections of a pane with drops when illuminated at −115° measured with respect to the optical axis. The Figure shows a detail of a focused drop region, a so-called secondary image, in the case of a camera assembly having two focal lengths. The primary image corresponds to a surrounding area, and the secondary image to the focused drops on the pane.

FIG. 22 shows an image 1701 depicting a simulation of the reflections of a pane with drops when illuminated at −115°. The primary image and the secondary image are shown.

The second optical radiation utilizes the Fresnel reflections. The Fresnel reflections occur at the inner and outer surfaces of the pane. Depending on the material, the angle of the incident radiation and the treatment state of the pane surfaces, the Fresnel reflections differ in intensity. If the input angle for the second optical radiation is chosen accordingly, Fresnel reflections occur at the inside of the pane and at the outside of the pane. In the regions in which drops are situated, the radiation is coupled out and hence those regions exhibit a lower degree of reflection, as illustrated in FIGS. 23 and 24. Here, the rain sensor principle currently used, utilizing total reflection in dependence on the medium situated on the pane, is applied as it were in imaging form. The drops on the outside of the pane interrupt the Fresnel reflections and “holes” appear in the image, as illustrated in FIGS. 23 and 24.

FIG. 23 shows an image 1801 depicting a simulation of the reflections of a pane with drops when illuminated at −130°. The Figure shows a detail of a focused drop region, a so-called secondary image, in the case of a camera assembly having two focal lengths. The primary image corresponds to a surrounding area, and the secondary image to the focused drops on the pane.

FIG. 24 shows an image 1801 depicting a simulation of the reflections of a pane with drops when illuminated at −130°. The primary image and the secondary image are shown.

Using an adapted algorithm, a more reliable detection of the drops may be obtained from two images taken in succession, namely one with an artificial first optical radiation and one with an artificial second optical radiation. For that purpose, there is the possibility of superposing the images in inverted form and thereby obtaining a higher SNR. In addition, owing to the two lightings which differ from each other, the system is more independent of the surrounding background, for example in relation to brightness and contrast, and also is more independent of the drop shape.

The form of lighting must be adapted to the sensitive surface area in order to obtain as far as possible good illumination of the entire sensitive region. Various possibilities exist for implementing the lighting for the second and third optical radiation.

It is possible to use two lightings that are separate from each other. Or a light source that is variable in position and/or variable in direction in its radiation emission and that is able to produce the two radiations alternately is used. It is also possible to use a lighting that may be altered in its direction by an optical element, for example a mirror or a lens.

When a lighting with a plurality of wavelengths, that is, at least two different wavelengths, is used, it is possible to use for that purpose, for example, a dichroitic element which divides the radiation emanating from the light source into the first and second optical radiation. In addition, with all the lighting variants, there is the possibility of using at the same time the optical additional components of the pane focusing. For example, the mirrors that serve for refocusing of a pane region, for example for the secondary image, may be used to divert the additional lighting. It is thereby possible, on the one hand, to position the light source itself at suitable locations outside of the vision cone of the camera and, on the other hand, also to save on further additional beam-guiding elements in that manner.

The Fresnel reflections occurring in the primary image, for example visible in FIG. 24, may be prevented by synchronization of the lighting with the roller shutter method of the camera, and therefore do not constitute a disadvantage.

The use of the present invention is possible in all vehicles having an automotive video camera that also includes integrated rain detection. Use may also be made in conjunction with introduction of a video-based rain sensor.

The exemplary embodiments described and shown in the Figures have been selected merely by way of example. Different exemplary embodiments may be combined in their entirety or in respect of individual features. An exemplary embodiment may also be supplemented by features of a further exemplary embodiment. Furthermore, method steps according to the invention may be repeated and may be performed in a different order from that described.

The signal processing steps described and shown have been selected merely by way of example. They may be replaced by other suitable or equivalent steps. The approaches according to the present invention may also be used in the case of panes that are not situated on vehicles.

1-15. (canceled)

16. A method for determining a structural image of a pane, the structural image being suitable for the detection of a visibility impairment of the pane, especially raindrops, the method comprising:
removing a background brightness from an image of the pane, on which image a surface of the pane is shown in focus and a background of the pane is shown out of focus, in order to determine a structural image of the pane; and
accentuating image structures present in the structural image in order to determine an enhanced structural image of the pane.

17. The method of claim 16, wherein, in the accentuating, edge lines present in the structural image are accentuated in order to determine the enhanced structural image of the pane, which enhanced structural image is suitable for the detection of the visibility impairment of the pane.

18. The method of claim 16, wherein, in the accentuating, extreme values present in the structural image are accentuated to a greater extent than are further values present in the structural image, in order to determine the enhanced structural image of the pane.

19. The method of claim 16, further comprising:
ascertaining the background brightness of the image in order to determine a background brightness image of the pane; and
combining the background brightness image with at least one of the structural image and with the enhanced structural image in order to determine a corrected structural image of the pane, which corrected structural image is suitable for the detection of the visibility impairment of the pane.

20. The method of claim 19, further comprising:
enhancing edge lines present in the background brightness image in order to determine an enhanced background brightness image;
wherein in the combining, the enhanced background brightness image is combined with at least one of the structural image and with the enhanced structural image.

21. The method of claim 19, further comprising:
accentuating bright regions of the background brightness image in order to determine an additional enhanced background brightness image;
wherein in the combining, the additional enhanced background brightness image is combined with at least one of the structural image and with the enhanced structural image.

22. A method for detecting a visibility impairment of a pane, caused especially by raindrops, the method comprising:
evaluating structures of a structural image of the pane;
wherein on the structural image a surface of the pane is shown in focus and a background of the pane is shown out of focus, in order to detect the visibility impairment of the pane.

23. The method of claim 22, wherein, in the evaluating, a mean value or a sum over the structural image or a number of structures is determined, and wherein the visibility impairment of the pane is detected based on the mean value, the sum or the number.

24. The method of claim 22, further comprising:
combining a first structural image of the pane with at least one further structural image of the pane preceding it in time in order to determine a combined structural image of the pane;
wherein, in the evaluating, structures of the combined structural image are evaluated in order to detect the visibility impairment of the pane.

25. The method of claim 24, wherein, in the combining, a combination is carried out between the first structural image and the further structural image in order to accentuate structures that both the first structural image and the further structural image have.

26. The method of claim 24, wherein, in the combining, a combination is carried out between the first structural image and the further structural image in order to accentuate structures that either only the first structural image or only the further structural image has.

27. A method for detecting a contamination of a pane, caused especially by raindrops, the method comprising:
evaluating a first image of the pane, which is based on a reflection of a first optical radiation, and a second image of the pane, which is based on a reflection of a second optical radiation, in order to detect the contamination;
configuring the first optical radiation to be reflected at a contaminated region of the pane; and
configuring the second optical radiation to be reflected at a contamination-free region of the pane.

28. The method of claim 27, wherein one of the first image and the second image is inverted and superposed with the respective other image in order to determine a superposed image, and wherein, in the evaluating, the superposed image is evaluated in order to detect the contamination.

29. An apparatus for determining a structural image of a pane, the structural image being suitable for the detection of a visibility impairment of the pane, especially raindrops, comprising:
a removing arrangement to remove a background brightness from an image of the pane, on which image a surface of the pane is shown in focus and a background of the pane is shown out of focus, in order to determine a structural image of the pane; and
an accentuating arrangement to accentuate image structures present in the structural image in order to determine an enhanced structural image of the pane.

30. A computer readable medium having a computer program, which is executable by a processor, comprising:
a program code arrangement having program code for determining a structural image of a pane, the structural image being suitable for the detection of a visibility impairment of the pane, especially raindrops, by performing the following:
a removing arrangement to remove a background brightness from an image of the pane, on which image a surface of the pane is shown in focus and a background of the pane is shown out of focus, in order to determine a structural image of the pane; and
an accentuating arrangement to accentuate image structures present in the structural image in order to determine an enhanced structural image of the pane.
